(19) United States
(12) Patent Application Publication
(10) Pub. No.: US 2013/0015398 A1
(43) Pub. Date: Jan. 17, 2013

(54) METHOD FOR PREPARING MODIFIED MICRONIZED PARTICLES

(71) Applicants: Ying Zhang, Shandong (CN); Gang Liu, Shandong (CN)

(72) Inventors: Ying Zhang, Shandong (CN); Gang Liu, Shandong (CN)

(73) Assignee: JINNENG SCIENCE & TECHNOLOGY CO., LTD., Shandong (CN)

(21) Appl. No.: 13/575,963

(22) PCT Filed: Jan. 28, 2011
(86) PCT No.: PCT/CN2011/070751

§ 371 Date: Oct. 4, 2012

(30) Foreign Application Priority Data
Jan. 29, 2010 (CN) 201010103394.5
May 25, 2010 (CN) 201010183854.X
Dec. 3, 2010 (CN) 201010572327.8

(51) Int. Cl. C09K 3/00; B82Y 40/00; B82Y 30/00

(52) U.S. Cl. 252/182.12; 252/182.11; 252/182.33; 252/182.34; 252/182.35; 252/182.32; 977/773; 977/900

(57) ABSTRACT

The present invention provides a method for preparing modified micronized particles, comprising the steps of carrying out co-precipitation in an aqueous solution at a temperature between the freezing point and the boiling point of the reaction mother liquid to produce a mixed precipitate of micronized particles or precursors thereof and an inorganic precipitate. The method effectively solves the conflict between micronization and surface modification of particles, and resolves the problem that it is difficult to separate micronized particles from the reaction mother liquid.

### TECHNICAL FIELD

The present invention relates to the technical field of chemical industry, and particularly to a method for preparing modified micronized particles.

### BACKGROUND ART

In the chemical reactions for nucleation and growth of water-insoluble micronized particles, strong adhesion generally forms between the particles, and as a result, in later applications, these micronized particles can only be dispersed in a matrix they filled at a size of several microns or even tens of microns with very poor monodispersity (a poor secondary particle size). In terms of applicability and performance, these particles are markedly inferior to submicron scale or even nanoscale micronized particles.

In current industrial production, in order to obtain modified micronized particles having a good secondary particle size, these monodispersed micronized particles are generally produced in an aqueous environment with addition of a small-molecule dispersant during the synthesis. However, such a method usually has the problems described below.

Firstly, there is often conflict between micronization and surface modification of the particles.

For preparation of any composite material, treatment of the interface between different materials is crucial, and the quality of the treatment has a direct impact on the final property of the composite material.

For micronized particles of various materials, if the interface is not properly treated or modified, not only the particles are difficult to be dispersed uniformly in a matrix material, but also the overall performance of the matrix material will generally be impaired. When viewed with a microscope, there is an interspace zone between the micronized particles and the matrix material, showing apparent separation between the two phases, examples of which are numerous.

Therefore, for micronization of particles, in most cases, the modification quality of the particles surface is much more important than the particle size of the particles.

As mentioned above, by currently available synthesis methods, modified micronized particles can be well dispersed in the matrix material, i.e. water. However, as known to us, in endpoint applications, the matrix materials into which these particles will be added, e.g. plastics, fibers, or the like, are in general substantially different from water in properties. In order to be adapted to the new matrix materials, these particles have to be further modified. However, as the micronized particles produced by these methods have their active adsorption sites on the surface already occupied by the previous small-molecule dispersant which cannot be removed, the further modification at this stage becomes extremely difficult. In other words, no matter how these micronized particles are treated, it will be difficult to achieve an ideal modification on their surface, which will inevitably bring about many limitations to later applications. For example, it is very difficult to directly apply the calcium carbonate particles prepared with a sodium polyacrylate dispersant into polypropylene plastics, and even if the particles are further modified with a corresponding coupling agent, an optimal interface fusion between the particles and polypropylene plastics cannot be achieved, resulting in an huge gap between the applicability and performance of such particles and those of nanoscale calcium carbonate particles produced by in situ polymerization.

Secondly, in traditional preparation processes, the micronized particles are also very difficult to be enriched. Because the micronized particles have a highly hydrophilic surface due to the modification with small-molecule dispersants and have a small size, it is difficult to filter out these particles and to separate them from the reaction mother liquid, and during the separation an issue of losing the micronized particles may arise.

### SUMMARY OF THE INVENTION

### Technical Problem

The objective of the present invention is to provide a method for preparing modified micronized particles, in order to solve the above-described technical problems currently present in methods for preparing modified micronized particles in the prior art.

### Technical Solution

The technical solutions provided by the present invention are described below.

In order to accomplish the above objective, the present invention provides a method for preparing modified micronized particles, comprising the step of carrying out co-precipitation in an aqueous solution at a temperature between the freezing point and the boiling point of the reaction mother liquid to produce a mixed precipitate of micronized particles or precursors thereof and an inorganic precipitate.

The mixed precipitate of micronized particles or precursors thereof and an inorganic precipitate accounts for 0.1%-50%, preferably 0.5%-10%, of the mother liquid after the reaction; and the mass ratio of the precipitated micronized particles or precursors thereof to the inorganic precipitate is from 1000:1 to 1:100000, preferably from 100:1 to 1:1000, and most preferably from 10:1 to 1:100.

The co-precipitation is carried out under a condition of typical stirring, or a condition of high-speed stirring/mixing/shearing/friction, and further proceeds under a condition of supergravity.

For the co-precipitation, the pH of the reaction liquid is controlled within the range of 3-14, preferably 7-14.

The micronized particles or precursors thereof are inorganic or organic substances insoluble in water and chemically non-reactive with water, or a mixture thereof.

The inorganic substance may be selected from chemical elements, and in particular is selected from Zn, Cr, Ga, Fe, Cd, In, Tl, Co, Ni, Mo, Sn, Pb, Cu, Tc, Po, Ag, Rh, Pd, Pt, Au, C, Si, W, B, Te, Se, S, or I, or a mixture thereof.

The inorganic substance may be selected from hydroxides, and in particular may be selected from actinium hydroxide, palladium(II, IV) hydroxide, bismuth hydroxide, platinum hydroxide, erbium hydroxide, gadolinium hydroxide, cadmium hydroxide, hafnium(III, IV) hydroxide, holmium hydroxide, gallium hydroxide, lutetium hydroxide, aluminum hydroxide, magnesium hydroxide, manganese hydroxide, lead(II, IV) hydroxide, cerium(III, IV) hydroxide, ferric hydroxide, ferrous hydroxide, cuprous hydroxide, cupric hydroxide, indium hydroxide, europium hydroxide, beryllium hydroxide, zinc hydroxide, nickel hydroxide, tin hydroxide, lanthanum hydroxide, neodymium hydroxide, praseodymium hydroxide, samarium hydroxide, terbium hydroxide, yttrium hydroxide, dysprosium hydroxide, thulium hydroxide, ytterbium hydroxide, scandium hydroxide, plutonium hydroxide, thorium hydroxide, neptunium hydroxide, uranium hydroxide, titanium hydroxide, zirconium hydroxide, vanadium(II, III, IV) hydroxide, niobium hydroxide, tantalum hydroxide, chromium hydroxide, cobalt hydroxide, or molybdenum(III, IV, V) hydroxide.

The inorganic substance may be selected from oxides, and in particular may be selected from actinium oxide, palladium(II, IV) oxide, bismuth oxide, platinum oxide, erbium oxide, gadolinium oxide, cadmium oxide, hafnium(III, IV) oxide, holmium oxide, gallium oxide, lutetium oxide, aluminum oxide, magnesium oxide, manganese oxide, lead(II, IV) oxide, cerium(III, IV) oxide, ferric oxide, ferrous oxide, cuprous oxide, cupric oxide, indium oxide, europium oxide, beryllium oxide, zinc oxide, nickel oxide, tin oxide, lanthanum oxide, neodymium oxide, praseodymium oxide, samarium oxide, terbium oxide, yttrium oxide, dysprosium oxide, thulium oxide, ytterbium oxide, scandium oxide, plutonium oxide, thorium oxide, neptunium oxide, uranium oxide, titanium oxide, zirconium oxide, vanadium(II, III, IV) oxide, niobium oxide, tantalum oxide, chromium oxide, cobalt oxide, molybdenum(III, IV, V) oxide, silver oxide, technetium oxide, polonium oxide, rhodium oxide, palladium oxide, platinum oxide, gold oxide, silicon oxide, tungsten oxide, boron oxide, tellurium oxide, or selenium oxide.

The inorganic substance may be selected from inorganic salts, and in particular may be selected from barium arsenate, barium carbonate, barium chromate, barium ferrocyanide, barium fluorosilicate, barium fluoride, barium hydrogen phosphate, barium iodate, barium sulfate, barium molybdate, barium permanganate, barium pyrophosphate, barium selenate, bismuth arsenate, bismuth iodide, bismuth phosphate, bismuth sulfide, platinum(IV) bromide, plutonium(III) fluoride, plutonium(IV) fluoride, plutonium(IV) iodate, calcium arsenate, calcium fluoride, calcium hydrogen phosphate, calcium molybdate, calcium phosphate, calcium tungstate, cadmium arsenate, cadmium carbonate, cadmium cyanide, cadmium ferrocyanide, cadmium iodate, cadmium phosphate, cadmium sulfide, cadmium tungstate, mercurous azide, mercurous bromide, mercurous carbonate, mercurous chloride, mercurous chromate, mercurous cyanide, mercurous sulfate, mercuric iodate, mercuric iodide, mercuric sulfide, mercuric thiocyanide, potassium tetraphenylborate, gold triiodide, lanthanum iodate, lanthanum molybdate, lithium phosphate, magnesium fluoride, magnesium phosphate, magnesium selenite, manganese carbonate, manganese ferrocyanide, nickel carbonate, nickel iodate, nickel pyrophosphate, polonium(II) sulfide, praseodymium(III) molybdate, lead azide, lead carbonate, lead chlorate, lead chromate, lead ferrocyanide, lead fluoride, lead hydrogen phosphate, lead hydrogen phosphite, lead iodate, lead iodide, lead molybdate, lead selenate, lead sulfate, lead sulfide, lead thiosulfate, lead tungstate, lead telluride, cerium(III) phosphate, strontium chromate, strontium sulfate, thallous bromide, thallous iodate, thallous iodide, ferrous carbonate, ferrous hydroxide, ferric arsenate, ferric fluoride, cuprous chloride, cuprous cyanide, cuprous iodide, cuprous sulfide, cuprous thiocyanide, cupric carbonate, cupric chromate, cupric fluoride, cupric selenite, cupric sulfide, thorium(IV) iodate, zinc carbonate, zinc cyanide, zinc iodate, yttrium fluoride, indium iodate, indium sulfide, silver azide, silver bromide, silver carbonate, silver chloride, silver chromate, silver cyanide, silver vanadate, beryllium carbonate, barium sulfite, strontium sulfite, calcium sulfite, beryllium sulfite, manganese sulfite, zinc sulfite, cadmium sulfite, ferrous sulfite, nickel sulfite, lead sulfite, cupric sulfite, mercuric sulfite, silver sulfite, strontium sulfide, manganese sulfide, zinc sulfide, ferrous sulfide, cadmium sulfide, nickel sulfide, tin sulfide, lead sulfide, cupric sulfide, mercuric sulfide, silver sulfide, barium silicate, calcium silicate, magnesium silicate, aluminum silicate, beryllium silicate, manganese silicate, zinc silicate, chromium silicate, ferrous silicate, ferric silicate, cadmium silicate, nickel silicate, lead silicate, cupric silicate, silver silicate, lithium phosphate, barium phosphate, strontium phosphate, calcium phosphate, magnesium phosphate, aluminum phosphate, beryllium phosphate, manganese phosphate, zinc phosphate, chromium phosphate, ferrous phosphate, ferric phosphate, cadmium phosphate, thallium phosphate, nickel phosphate, tin phosphate, lead phosphate, cupric phosphate, mercuric phosphate, silver phosphate, 2-mercapto zinc pyrithione, 2-mercapto copper pyrithione, cadmium oxalate, silver oxalate, ferrous oxalate, zinc tartrate, zinc oxalate, lead oxalate, lead tartrate, barium oxalate, calcium oxalate, mercuric oxalate, scandium oxalate, manganese oxalate, tungsten carbide, silicon carbide, boron carbide, silicon nitride, or boron nitride.

The inorganic substance may be selected from organic metal salts, and in particular may be selected from any salt formed by an anion of alkyl or aryl sulfate, sulfonate, phosphate, or carboxylate and the ion of Ba, Sr, Ca, Li, Ac, La, Ce, Pr, Nd, Sm, Eu, Gd, Tb, Y, Mg, Am, Dy, Ho, Er, Tm, Yb, Lu, Sc, Pu, Th, Np, Be, U, Hf, Al, Ti, Zr, V, Mn, Nb, Zn, Cr, Ga, Fe, Cd, In, Tl, Co, Ni, Mo, Sn, Pb, Cu, Tc, Po, Hg, Ag, Rh, Pd, Pt, or Au.

The organic substance has at least one of the following characteristics:

(1) its decomposition temperature is higher than its melting point, and

(2) at or below its decomposition temperature, it is soluble in any liquid or liquid composition other than water, with a solubility not less than 1 g/100 g,

wherein the liquid or liquid composition other than water may particularly selected from an organic solvent or a combination of organic solvents which can be dissolved at least 1 gram in 100 gram water at 25° C.

The present invention may further comprise a step of adding a purifying agent into the mixed precipitate, removing part of the inorganic precipitate and post-transformed products thereof by converting them into soluble substances, and washing and concentrating the remaining precipitate.

The purifying agent is a water-soluble inorganic or organic acid that may be one selected from hydrochloric acid, sulfuric acid, nitric acid, hydrofluoric acid, acetic acid and phosphoric acid, or a mixture thereof.

The present invention may further comprise a step of adding a purifying agent into the mixed precipitate, removing all of the inorganic precipitate and post-transformed products thereof by converting them into soluble substances, and washing and concentrating the remaining precipitate.

The present invention may further comprise a step of allowing the purified mixed precipitate to mix/react with a surface modifying agent to obtain modified micronized particles.

The surface modifying agent refers to a compound able to be adsorbed to the surface of the micronized particles, and includes anionic compounds, cationic compounds, nonionic surfactants, water-insoluble organic liquids, coupling agents, or matrix materials to which the particles are added, and compositions thereof.

The volume average value of the secondary particle size (d50) of the modified micronized particles is less than 10 pm, preferably less than 1000 nm, more preferably less than 100 nm, and most preferably less than 10 nm.

The present invention may further comprise precipitating the micronized particles or precursors thereof in an aqueous solution at a temperature between the freezing point and the melting point of the mother liquid in the presence of an inorganic precipitate that can be converted into soluble substances.

The inorganic precipitate that can be converted into soluble substances has solubility at the reaction temperature of less than 1 g/100 g water, preferably less than 0.01 g/100 g water. The cation portion of the inorganic precipitate is selected from ions of Ba, Sr, Ca, Li, Ac, La, Ce, Pr, Nd, Sm, Eu, Gd, Tb, Y, Mg, Am, Dy, Ho, Er, Tm, Yb, Lu, Sc, Pu, Th, Np, Be, U, Hf, Al, Ti, Zr, V, Mn, Nb, Zn, Cr, Ga, Fe, Cd, In, Tl, Co, Ni, Mo, Sn, Pb, Cu, Tc, Po, Hg, Ag, Rh, Pd, Pt, and Au, or a mixture thereof; and the anion portion of the inorganic precipitate is selected from a cyanide ion, a halide ion, a (hydrogen) sulfate ion, a nitrite ion, a (hydrogen) carbonate ion, a (hydrogen) sulfite ion, a bichromate ion, a (hydrogen) phosphate ion, a (hydrogen) sulfide ion, a chromate ion, a silicate ion, a borate ion, an arsenate ion, a titanate ion, an oxalate ion, a hydroxide ion, or a oxide ion, and in particular may be a hydroxide ion, an oxide ion, a (hydrogen) sulfide ion, a (hydrogen) sulfite ion, a (hydrogen) phosphate ion, or a (hydrogen) carbonate ion, or a mixture thereof.

In the present invention, a surfactant substance is added before, during, and/or after the precipitation, and such addition does not influence separation of the mixed precipitate from the mother liquid or the treatment of the waste water.

Specific surfactant substances may be found in Application Principles of Surfactants, Chemical Industrial Press, China.

The present invention also provides a method for preparing modified micronized barium sulfate, comprising the steps of

(1) allowing a co-precipitation reaction with an aqueous solution containing at least a water-soluble barium salt with an aqueous solution containing at least a water-soluble sulfate to at a temperature between 0° C. and 99° C., so as to obtain a mixed precipitate of barium sulfate precipitate and another inorganic precipitate, wherein the inorganic precipitate can be converted into water-soluble substances under the action of a purifying agent;

(2) allowing the mixed precipitate obtained in step (1) to settle down and age;

(3) mixing the mixed precipitate after aging with a surface modifying agent and allowing them to react, so as to obtain modified micronized barium sulfate.

Between step (2) and step (3), there may be a further step of adding a purifying agent to the mixed precipitate after aging to completely remove the inorganic salt precipitate, and washing and concentrating the remaining precipitate.

Between step (2) and step (3), there may be a further step of adding a purifying agent to the mixed precipitate after aging to partially remove the inorganic salt precipitates, and washing and concentrating the remaining precipitate.

### Beneficial Effects

In the method for preparing modified micronized particles according to the present invention, introduction of an inorganic precipitate that can be separated inhibits the adhesion between micronized particles during formation, growth, and aging, and results in particles having a desired micronized particle size. Furthermore, with conventional instruments, the precipitates of these micronized particles or precursors thereof may be readily seperated from the reaction mother liquid. Moreover, after selective treatment with various surface modifying agents, highly specific modified micronized particles which are suitable for various materials and have an excellent secondary particle size can be obtained, wherein the secondary particle size can be within nanoscale range. Therefore, the present invention effectively overcomes the drawback that there is conflict between the particle micronization and surface modification of modified micronized particles in the prior art and the drawback that it is difficult to separate micronized particles from reaction mother liquid. The present invention can easily afford modified micronized particles with improved performance and an excellent secondary particle size and can realize industrial production of nanoscale micronized particles.

In addition, in the present invention, the degree to which the inorganic precipitate is removed is flexible. Depending on specific application and the type of the inorganic precipitate, the inorganic precipitate can be intact, partially removed, or completely removed. Therefore, the present invention is advantageous in providing flexibility, enlarging the versatility of application performance of the micronized particles, as well as saving time, efforts, and cost.

### BEST MODE FOR CARRYING OUT THE INVENTION

### Embodiments of the Invention

According to the present invention, a method for preparing modified micronized particles comprises the steps of carrying out co-precipitation in an aqueous solution at a temperature between the freezing point and the boiling point of the reaction mother liquid to produce a mixed precipitate of micronized particles or precursors thereof and an inorganic precipitate.

According to the present invention, the method for preparing modified micronized particles may further comprise a step of adding a purifying agent into the mixed precipitate, removing part of the inorganic precipitate and post-transformed products thereof by converting them into soluble substances, and washing and concentrating the remaining precipitate.

According to the present invention, the method for preparing modified micronized particles may further comprise a step of adding a purifying agent into the mixed precipitate, removing all of the inorganic precipitate and post-transformed products thereof by converting them into soluble substances, and washing and concentrating the remaining precipitate.

According to the present invention, the method for preparing modified micronized particles may further comprise a step of allowing the purified mixed precipitate to mix/react with a surface modifying agent to obtain modified micronized particles.

According to the present invention, a method for preparing modified micronized particles comprises precipitating the micronized particles or precursors thereof in an aqueous solution at a temperature between the freezing point and the melting point of the mother liquid in the presence of an inorganic precipitate able to be converted into soluble substances.

In the above method, although the precipitation mentioned herein takes place in an aqueous solution, the aqueous solution may contain other liquid components, for example, organic solvents such as ethanol.

In the above method, it can also be understood that the reaction carried out in an aqueous solution takes place in the mother liquid in a state between frozen and boiling and refluxing. Theoretically, pure water is solid below its freezing point of 0° C. and gaseous above its boiling point of 100° C. However, in fact, the freezing point and boiling point of water actually fluctuate in the presence of inorganic salts or other substances. In particular, such fluctuation of the freezing point and boiling point of the mother liquid becomes markedly considerable under an increased reaction pressure. This is well known to a person ordinarily skilled in chemical industry.

In the above method, the production of the mixed precipitate by co-precipitation is a hybrid reaction process over a certain period, including both the reaction process of precipitation of the micronized particles or precursors thereof and the reaction process of synthesis of a removable inorganic precipitate. As it is impossible for these two processes to have absolutely consistent reaction velocity, there must be the issue that they do not proceed at the same pace. Accordingly, in order to delimit the period spanned by the co-precipitation, the entire process including nucleation, growth, and aging of the precipitate of micronized particles or precursors thereof should be taken into consideration. Introduction of the aforementioned removable inorganic precipitate at any time during this process should be considered as falling within the scope of protection of the present invention. In summary, introduction of the removable inorganic precipitate de facto results in a reduced size of micronized particles, which can be easily confirmed with instruments such as a laser particle size distribution analyzer. Similarly, precipitation of micronized particles or precursors thereof may be carried out in the presence of the inorganic precipitate, and since such an embodiment also results in a reduced size of the micronized particles, it also falls within the scope of protection of the present invention.

The inorganic precipitate produced by the method of the present invention is characterized in that it can be conveniently converted into water-soluble substances with typical inorganic or organic acids. Separation between micronized particles precipitate and the inorganic precipitate is effected on the basis of the fact that in an aqueous solution the inorganic precipitate has lower stability against acid or needs a higher pH value to be stabilized as compared to the micronized particles. However, such separation does not have to be indispensable or complete. For example, as widely known, aluminum hydroxide is often used in plastic products to improve flame retardancy. Accordingly, calcium carbonate and an inorganic precipitate aluminum hydroxide can be dispersed, or added together after being modified, into plastic products without separation.

In the above method, an aging treatment is preferred. Generally, depending on the reaction conditions, the aging time can be selected within the range of 0-24 hours depending on the aging temperature. After aging, purification of the mixed precipitate is flexible, i.e. the mixed precipitate may be partially treated, completely treated, or non-treated with a purifying agent, and such flexibility may depend on the needs of specific applications and the type of the inorganic precipitate. If purification treatment is required, the order between the purification treatment and the washing and concentrating may be varied, i.e., the treatment with a purifying agent may be prior or subsequent to the washing and concentrating. For solid-liquid separation in various stages of treatment, methods such as gravity sedimentation, vacuum filtration, centrifugal filtration, or centrifugal sedimentation may be used, and in particular, devices like a gravity sedimentation vessel, a filtration-type or sedimentation-type tripod centrifuge, and a frame pressure filter may be used.

In the above method, the precursors of micronized particles and the post-transformed products of the inorganic precipitate are general technical terms used in preparation of micronized particles. For example, in preparation of elemental copper by co-precipitation of cupric sulfate and magnesium chloride, cupric oxide produced in an early stage is a precursor of the finally produced micronized elemental copper. For another example, in co-precipitation reaction for preparing oxides using calcium chloride-derived calcium hydroxide as a dispersant, the calcium oxide produced after heating and dehydration is a transformed product of the previously co-precipitated calcium hydroxide. This is fully understood in the prior art.

In the above method, the anion portion of the inorganic precipitate may particularly be selected from a hydroxide ion, an oxide ion, a (hydrogen) sulfide ion, a (hydrogen) sulfite ion, a (hydrogen) phosphate ion, or a (hydrogen) carbonate ion, or a mixture thereof. The donor of these anions may directly take the form of salt, e.g. sodium carbonate, or may be in a gaseous form, e.g. ammonia gas to be dissolved in water to form hydroxide anions, or carbon dioxide to be dissolved in water to form sodium carbonate with sodium hydroxide. Furthermore, anions such as basic carbonates may be regarded as a mixture of carbonate anions and hydroxide anions, which is also contemplated in the scope of protection of the present invention.

The volume average value of the secondary particle size (d50) of the modified micronized particles produced by the method of the present invention is less than 10 μm, preferably less than 1000 nm, more preferably less than 100 nm, and most preferably less than 10 nm. The particle size may be determined specifically with a laser particle size distribution analyzer, scanning electron microscope (SEM) or the like.

The co-precipitation of the present invention may be carried out under a typical stirring condition, for example, in a porcelain enamel reaction kettle conventionally used in chemical industrial production, or more preferably under a condition of high-speed stirring/mixing/shearing/friction, for example, under the high-speed stirring in a GFJ-type dispersion machine (Laizhou Shenglong Chemical Industrial Machinery Factory, Shandong, China), or most preferably under a condition of supergravity, for example, in a supergravity reaction apparatus based on the principle of supergravity (for its specific forms, see Supergravity, Technology and Applications, Chemical Industrial Press).

In the present invention, a surfactant substance may be further added before, during, and/or after the precipitation, and such addition does not influence separation of the mixed precipitate from the mother liquid or the treatment of waste water. In particular, preferred surfactant substances are selected from anionic alkyl or aryl organic compounds, including alkyl or aryl sulfate, sulfonic acid, phosphate, or carboxylic acid and salts thereof, or a mixture thereof, and are added in an amount of 0.05% to 100%, preferably 0.05% to 40%, most preferably 0.1% to 10%, of the weight of the precipitate of micronized particles or precursors thereof. In other similar conditions, the physical and/or chemical adsorption caused by such addition facilitates further particle-size micronization of precipitated micronized particles or precursors thereof, improves the lipophilicity of inorganic particles, and facilitates the controllable variation in particle shape and appearance. However, the addition should not impact on the separation of the mixed precipitate from the mother liquid and on the treatment of waste water, to such an extent that, with a given formulation, turbidity of the mother liquid from which the mixed precipitate has been separated does not increase and the surfactant substances not adsorbed onto the micronized particles present in the waste water do not increase the difficulty in treating waste water, which can be readily judged in the prior art. The surfactant substances include anionic alkyl or aryl organic compounds, such as linoleic acid, oleic acid, stearic acid, sodium stearyl ether sulfate, dioctyl succinate sulfate salt, (di)butyl naphthalene sulfonate, (iso)stearoyl lactylate, poly(alkyl naphthalene sulfonate), dodecyl benzene phosphate salt, polycarboxylate, and dinaphthenate. These surfactant substances may certainly include inorganic anionic compounds, such as sodium polyphosphate and sodium hypophosphite; other types of surfactants, such as ethanol, dodecyl betaine, octadecyl ammonium salts, and fatty alcohol-polyoxyethylene ether; organic polymer compounds, such as polyvinyl alcohol, polyacrylamide, and polyvinyl pyrrolidone; and the like. These surfactant substances may be used alone or in combination, and their specific forms may be found in Application Principles of Surfactants, Chemical Industrial Press, China.

In the method of the present invention, optional surface modifying agents include compounds able to be adsorbed to the surface of micronized particles, including anionic compounds, cationic compounds, nonionic surfactants, organic solvents, coupling agents, or matrix materials to which the particles are added, and a composition thereof.

After the previous treatment, micronized particles are present with only weak physical adhesion (also informally referred to as soft aggregation) between them, can be converted into monodispersed micronized particles satisfying the modification requirement after mixing/reacting with surface modifying agents, and then may be conveniently added into a matrix material.

In late-stage surface modification, the method shows distinct advantages. For example, the nanoscale calcium carbonate particles produced according to the method of the present invention do not need further complex treatment, and can be directly deaggregated and dispersed in an aqueous solution containing the naphthalene sulfonate formaldehyde condensate dispersant MIGHTY150, in a liquid paraffin containing oleic acid, in an aqueous solution containing oleic acid and the penetrant JFC, in an aqueous solution containing the anionic organic pigment Fluorescent Yellow and the nonionic surfactant penetrant JFC, or in a general pure acrylic emulsion containing 3% acrylic acid groups. In summary, the micronized calcium carbonate produced by the present method provides various modification possibilities for its future applications.

Therefore, for different application purposes, there is a wide range of choices of modifying agents covering the six categories below.

1. Anionic compounds, including anionic inorganic compounds and anionic organic compounds. Generally, chemical adsorption can form between these anionic compounds and the metal ions exposed on the surface of micronized particles mainly via ionic bonds. More specifically, these anionic compounds include
A. anionic inorganic compounds, such as a fluoride ion, a silicate anion, a phosphate anion, and the like;
B. anionic organic compounds, including
   B1. surfactants/dispersants with anion groups of a sulfonic acid group, a phosphoric acid group or a carboxyl group, for example, a polycarboxylate dispersant, stearic acid, oleic acid, a poly(naphthalene sulfonate) dispersant, etc., and their specific forms may be found in Application Principles of Surfactants, Chemical Industrial Press, China;
   B2. chelating agents, including sodium triphosphate, sodium polyphosphate, EDTA-2Na, maleic acid, citric acid, sodium pyrithione, oxalic acid, triethanolamine, etc.;
   B3. solution or emulsion of resins having anionic segments, wherein, some segments of the anionic resin have carboxyl groups or sulfonic acid groups, and account for 0.1% to 99.9% of the whole polymer which may be water-soluble, water-dispersible, or oil-soluble, and examples are sodium carboxymethyl starch, polystyrene-sodium sulfonate, styrene-acrylic resin solution or emulsion, silicone acrylic resin solution or emulsion, carboxyl silicone oil solution or emulsion, etc.

2. Cationic compounds, including cationic inorganic compounds and cationic organic compounds.
A. Cationic inorganic compounds, including barium ion, magnesium ion, aluminum ion, etc. For example, when the micronized calcium carbonate produced by the present method is modified with an anionic dye or pigment, addition of the above ions can increase the adsorption stability of the anionic dye or pigment. For another example, when the micronized calcium carbonate produced by the present method is modified with sodium carboxymethyl cellulose, addition of the above ions can increase the adsorption stability of sodium carboxymethyl cellulose.
B. Cationic organic compounds, including alkyl ammonium chloride, aryl ammonium chloride, poly(ethyleneimine), cationic guar gum, etc. Their specific forms may be found in Application Principles of Surfactants, Chemical Industrial Press, China.

3. Nonionic surfactants, including alkyl polyethylene glycol ether, aryl polyethylene glycol ether, polyethylene glycol-polypropylene glycol ether, polyvinyl alcohol, polyvinyl pyrrolidone, polyethylene wax emulsion, etc. Their specific forms may be found in Application Principles of Surfactants, Chemical Industrial Press, China.

4. Water-insoluble organic liquids, including all organic liquids having solubility of no more than 0.1 g/100 g water at 25° C., which may have a single component or mixed components. Using the micronized particles produced by the method of the present invention as a carrier to carry a water-insoluble liquid medicament and making the medicament in nanosize is an example of practicing the present invention. Carriers suitable for this purpose include all micronized particles set forth in the present invention.

5. Coupling agents, including silicane coupling agents, such as vinyltrichlorosilane (A-150), vinyltriethoxysilane (A-151), vinyltrimethoxysilane (A-171), γ-(2,3-epoxypropoxy)propyltrimethoxysilane (A-187, KH-560), etc.; titanate coupling agents, such as isopropyl tri(dioctyl pyrophosphate) titanate (KR-38S), isopropyl tri(isostearoyl) titanate (KR-TTS), isopropyl tri(dodecylbenzenesulfonyl) titanate (KR-9S), isopropyl tri(N-ethylamino-ethylamino) titanate (KB-44), etc.; aluminate coupling agents; and the like.

6. The particles may be directly added into a matrix material which includes plastics, rubber, fiber, paint, ink, metal, ceramic, and the like. For example, the calcium carbonate produced according to the present method may be directly added into a general pure acrylic emulsion containing 3% acrylic acid groups.

It is to be noted that these surface modifying agents may be used alone or as a mixture of two or more thereof. In some cases, means of treating such as heating, calcining, or drying during or after the modification are necessary, and can be routinely practiced according to known knowledge.

In general, the modification or dispersion according to the present invention can be accomplished with any conventional equipment, for example, an emulsion machine, a dispersion machine, vertical and horizontal sand mills, a blending kettle, etc. Other elegant dispersing, milling or modifying means can certainly be used.

The modified micronized particles according to the present invention are inorganic and organic materials which are water-insoluble and not chemically reactive with water. Herein, being water-insoluble or hard to dissolve in water is a generic quantified chemical concept, and substances having solubility of less than 0.01 gram in 100 g water at 25° C. are generally referred to as water-insoluble substances, which include chemical elements, hydroxides, oxides, inorganic salts, other inorganic compounds, organic metal salts, and organic compounds. The present invention aims to resolve the problems in micronization and surface modification of the above substances by appropriate introduction of an inorganic precipitate, characterized by formation of a mixed precipitate of the above substances and the inorganic precipitate. The process of forming such a mixed precipitate can be a physical process, a chemical reaction, or a combination of both. For example, dispersion of iodine dissolved in ethanol into a liquid containing calcium phosphate precipitate is a physical precipitation process. For another example, the process in which a molten organic compound is dispersed into a liquid containing an inorganic precipitate to form micronized particles of the organic compound is also a physical precipitation process. On the other hand, synthesis of modified micronized particles of some chemical elements, as well as hydroxides, oxides, inorganic salts, other inorganic compounds, some organic metal salts and some organic compounds, is a chemical precipitation reaction, which is characterized in that the modified micronized particles are formed after the precipitation reaction and have new molecular structures compared to the form before the precipitation reaction. For these precipitation processes that can be carried out by both chemical and physical methods, the skilled artisan can flexibly select a method depending on specific conditions. The above knowledge is well known to those ordinarily skilled in the field of chemical industry.

The methods for preparing modified micronized particles of the chemical elements, hydroxides, oxides, inorganic salts, other inorganic compounds, organic metal salts, and organic compounds according to the present invention are known and may often be varied. The variety of these preparation methods is not only reflected in the choice of raw materials (for example, aluminum hydroxide can be synthesized through the reaction between aluminum sulfate and sodium hydroxide, and also between aluminum sulfate and sodium sulfide), but also reflected in variation in process conditions for preparation. For example, a-alumina (also referred to as corundum) may be obtained by calcining aluminum hydroxide at 1200° C., or may also be synthesized by a hydrothermal method under a condition of high pressure and high alkalinity. Utilization of these known methods does not conflict with implementation of the technology of the present invention; use of the technology of the present invention to carry out co-precipitation may improve the micronization and surface modification of the particles synthesized by known methods.

Therefore, the embodiments further described below are not the only options, as the optimal embodiment will depend on the combination of various aspects such as the purity of the resultant micronized particles and the cost.

For production of micronized particles of elemental Zn, Cr, Ga, Fe, Cd, In, Tl, Co, Ni, Mo, Sn, and Pb, hydrogen gas may be selected to reduce a mixture of an oxide of the corresponding element and calcium oxide. For production of micronized particles of elemental Cu, Tc, Po, Ag, Rh, Pd, Pt, Au, and Te, hydrazine hydrate-based reductants may be selected to reduce the oxides of these elements in an aqueous solution. For production of micronized particles of elemental Ag, Rh, Pd, Pt, and Au, heat may be applied to a mixture of an oxide of the corresponding element and calcium carbonate. For production of micronized particles of elemental carbon, a mixed precipitate of calcium stearate and calcium carbonate may be subjected to incomplete burning in a sealed space. For production of micronized particles of elemental Si, W, and B, powder of metal magnesium or the like may be used to reduce a mixed precipitate of a hydrated oxide of the corresponding element and barium sulfate. For production of micronized particles of elemental Se, S, and I, they may be obtained by physical precipitation from an organic solution containing these elements.

Micronized particles of a hydroxide may be prepared through the reaction of a water-soluble metal salt corresponding to the hydroxide and a water-soluble base. Representative water-soluble bases include sodium hydroxide, potassium hydroxide, aqueous ammonia, and ammonia gas. For hydroxides capable of undergoing dual hydrolysis, for example, aluminium hydroxide, sodium carbonate, ammonia carbonate, sodium hydrogen carbonate, and sodium sulfide may also be selected. These hydroxides include actinium hydroxide, palladium(II, IV) hydroxide, bismuth hydroxide, platinum hydroxide, erbium hydroxide, gadolinium hydroxide, cadmium hydroxide, hafnium(III, IV) hydroxide, holmium hydroxide, gallium hydroxide, lutetium hydroxide, aluminum hydroxide, magnesium hydroxide, manganese hydroxide, lead(II, IV) hydroxide, cerium(III, IV) hydroxide, ferric hydroxide, ferrous hydroxide, cuprous hydroxide, cupric hydroxide, indium hydroxide, europium hydroxide, beryllium hydroxide, zinc hydroxide, nickel hydroxide, tin hydroxide, lanthanum hydroxide, neodymium hydroxide, praseodymium hydroxide, samarium hydroxide, terbium hydroxide, yttrium hydroxide, dysprosium hydroxide, thulium hydroxide, ytterbium hydroxide, scandium hydroxide, plutonium hydroxide, thorium hydroxide, neptunium hydroxide, uranium hydroxide, titanium hydroxide, zirconium hydroxide, vanadium(II, III, IV) hydroxide, niobium hydroxide, tantalum hydroxide, chromium hydroxide, cobalt hydroxide, and molybdenum(III, IV, V) hydroxide. According to the present invention, a general candidate to be co-precipitated together with the above hydroxides is calcium hydroxide (the inorganic precipitate).

For production of micronized particles of a metal oxide, a mixed precipitate of a hydroxide corresponding to the metal oxide and calcium hydroxide (the inorganic precipitate) may be decomposed by a hydrothermal method. The metal oxide includes actinium oxide, palladium(II, IV) oxide, bismuth oxide, platinum oxide, erbium oxide, gadolinium oxide, cadmium oxide, hafnium(III, IV) oxide, holmium oxide, gallium oxide, lutetium oxide, aluminum oxide, magnesium oxide, manganese oxide, lead(II, IV) oxide, cerium(III, IV) oxide, ferric oxide, ferrous oxide, cuprous oxide, cupric oxide, indium oxide, europium oxide, beryllium oxide, zinc oxide, nickel oxide, tin oxide, lanthanum oxide, neodymium oxide, praseodymium oxide, samarium oxide, terbium oxide, yttrium oxide, dysprosium oxide, thulium oxide, ytterbium oxide, scandium oxide, plutonium oxide, thorium oxide, neptunium oxide, uranium oxide, titanium oxide, zirconium oxide, vanadium(II, III, IV) oxide, niobium oxide, tantalum oxide, chromium oxide, cobalt oxide, molybdenum(III, IV, V) oxide, silver oxide, technetium oxide, polonium oxide, rhodium oxide, palladium oxide, platinum oxide, and gold oxide. As activities of these metals vary extensively, conditions for production thereof may be distinctly different from each other. For example, gold oxide may be directly obtained without heating. In addition, a calcining method may be selected. Normally, the corresponding hydroxide produced in previous processes is washed and concentrated, then dispersed into an alcohol solvent having a boiling point higher than that of water, particularly a polyol, e.g. 1,2-propylene glycol, and is heated to dryness.

For production of micronized particles of a non-metal oxide like silicon oxide, tungsten oxide, boron oxide, tellurium oxide, and selenium oxide, selected may be the method in which a mixed precipitate of a calcium salt corresponding to the oxide (generally the salt is also referenced as a complex of calcium oxide, the non-metal oxide, and water) and calcium carbonate is first synthesized and then heated until dehydrated, and the calcium carbonate is removed by acids.

Micronized particles of an inorganic salt may be prepared by co-precipitation from a mixture of a water-soluble metal salt corresponding to the inorganic salt and anions of a corresponding water-soluble acid and hydroxide/carbonate. Furthermore, an alternative choice is by reaction between insoluble hydroxide or carbonate of the corresponding metal ion and an acid having the corresponding anion. The inorganic salt includes barium arsenate, barium carbonate, barium chromate, barium ferrocyanide, barium fluorosilicate, barium hydrogen phosphate, barium fluoride, barium iodate, barium sulfate, barium molybdate, barium permanganate, barium pyrophosphate, barium selenate, bismuth arsenate, bismuth iodide, bismuth phosphate, bismuth sulfide, platinum(IV) bromide, plutonium(III) fluoride, plutonium(IV) fluoride, plutonium(IV) iodate, calcium arsenate, calcium fluoride, calcium hydrogen phosphate, calcium molybdate, calcium phosphate, calcium tungstate, cadmium arsenate, cadmium carbonate, cadmium cyanide, cadmium ferrocyanide, cadmium iodate, cadmium phosphate, cadmium sulfide, cadmium tungstate, mercurous azide, mercurous bromide, mercurous carbonate, mercurous chloride, mercurous chromate, mercurous cyanide, mercurous sulfate, mercuric iodate, mercuric iodide, mercuric sulfide, mercuric thiocyanide, potassium tetraphenylborate, gold triiodide, lanthanum iodate, lanthanum molybdate, lithium phosphate, magnesium fluoride, magnesium phosphate, magnesium selenite, manganese carbonate, manganese ferrocyanide, nickel carbonate, nickel iodate, nickel pyrophosphate, polonium(II) sulfide, praseodymium(III) molybdate, lead azide, lead carbonate, lead chlorate, lead chromate, lead ferrocyanide, lead fluoride, lead hydrogen phosphate, lead hydrogen phosphite, lead iodate, lead iodide, lead molybdate, lead selenate, lead sulfate, lead sulfide, lead thiosulfate, lead tungstate, cerium(III) phosphate, strontium chromate, strontium sulfate, thallous bromide, thallous iodate, thallous iodide, ferrous carbonate, ferrous hydroxide, ferric arsenate, ferric fluoride, cuprous chloride, cuprous cyanide, cuprous iodide, cuprous sulfide, cuprous thiocyanide, cupric carbonate, cupric chromate, cupric fluoride, cupric selenite, cupric sulfide, thorium(IV) iodate, zinc carbonate, zinc cyanide, zinc iodate, yttrium fluoride, indium iodate, indium sulfide, silver azide, silver bromide, silver carbonate, silver chloride, silver chromate, silver cyanide, silver vanadate, beryllium carbonate, barium sulfite, strontium sulfite, calcium sulfite, beryllium sulfite, manganese sulfite, zinc sulfite, cadmium sulfite, ferrous sulfite, nickel sulfite, lead sulfite, cupric sulfite, mercuric sulfite, silver sulfite, strontium sulfide, manganese sulfide, zinc sulfide, ferrous sulfide, cadmium sulfide, nickel sulfide, tin sulfide, lead sulfide, cupric sulfide, mercuric sulfide, silver sulfide, barium silicate, calcium silicate, magnesium silicate, aluminum silicate, beryllium silicate, manganese silicate, zinc silicate, chromium silicate, ferrous silicate, ferric silicate, cadmium silicate, nickel silicate, lead silicate, cupric silicate, silver silicate, lithium phosphate, barium phosphate, strontium phosphate, calcium phosphate, magnesium phosphate, aluminum phosphate, beryllium phosphate, manganese phosphate, zinc phosphate, chromium phosphate, ferrous phosphate, ferric phosphate, cadmium phosphate, thallium phosphate, nickel phosphate, tin phosphate, lead phosphate, cupric phosphate, mercuric phosphate, silver phosphate, 2-mercapto copper pyrithione, cadmium oxalate, silver oxalate, ferrous oxalate, zinc tartrate, zinc oxalate, lead oxalate, lead tartrate, barium oxalate, calcium oxalate, mercuric oxalate, scandium oxalate, and manganese oxalate.

Inorganic micronized particles of tungsten carbide, silicon carbide, boron carbide, silicon nitride, or boron nitride are also produced by reducing the mixed precipitate with carbon or nitrogen (ammonia gas) upon co-precipitation.

Micronized particles of organic metal salts may be produced by the same method as that for producing micronized particles of inorganic salts. The organic metal salts include any salt of alkyl or aryl sulfate, sulfonate, phosphate or carboxylate and Ba, Sr, Ca, Li, Ac, La, Ce, Pr, Nd, Sm, Eu, Gd, Tb, Y, Mg, Am, Dy, Ho, Er, Tm, Yb, Lu, Sc, Pu, Th, Np, Be, U, Hf, Al, Ti, Zr, V, Mn, Nb, Zn, Cr, Ga, Fe, Cd, In, Tl, Co, Ni, Mo, Sn, Pb, Cu, Tc, Po, Hg, Ag, Rh, Pd, Pt, or Au, for example, calcium stearate and zinc stearate commonly used for pharmaceutical adjuvants. It is to be noted that any alkyl or aryl sulfate, sulfonate, phosphate or carboxylate or a salt thereof may also undergo co-precipitation after dissolved in a solvent which is miscible with water, such as ethanol, or participate in co-precipitation as an aqueous emulsion.

Finally, the present invention further discloses a method for micronizing water-insoluble solid organic compounds. Carriers suitable for this purpose include all micronized particles set forth in the present invention, especially the inorganic micronized particles produced by the method of the present invention.

The water-insoluble solid organic compound has at least one characteristic of the character that its decomposition temperature is higher than its melting point, and the characteristic that at a temperature below its decomposition temperature, it is soluble in a liquid or liquid composition other than water, with solubility not less than 1 g/100 g.

For those water-insoluble solid organic compounds which can be obtained through a reaction between aqueous solutions, between an aqueous solution and gas, between an aqueous solution and a water-insoluble liquid, or between a water-insoluble liquid and gas, chemical precipitation processes may be employed.

The water-insoluble solid organic compounds may be melted to carry out physical precipitation processes.

The water-insoluble solid organic compound may participate in co-precipitation in the form of a solution thereof. The co-precipitation process generally comprises two physical precipitation processes, i.e., adsorption and deposition. When the solvent is completely insoluble in water, the precipitation process is primarily physical adsorption, and when the solvent is water-miscible, the precipitation process is primarily deposition. Among these two precipitation processes, deposition is more preferable. Therefore, when the water-insoluble solid organic compound participates in co-precipitation in the form of a solution thereof, the any liquid or liquid composition is preferably an organic solvent or a combination of organic solvents having solubility of at least 1 g or more in 100 g water at 25° C., for example, methanol, ethanol, acetone, ethylene glycol, propylene glycol, glycerol, polyethylene glycol 200/400, sulfolane, dioxane, hydroxypropionic acid, ethylamine, ethylenediamine, ethylene glycol monomethyl/monoethyl/monopropyl ether, diglycol dimethyl ether, 1,3-dioxa cyclopentane, etc. Their specific forms may be found in Handbook of Solvents by Nenglin Cheng, Chemical Industrial Press, China.

Furthermore, the water-insoluble solid organic compounds may optionally participate in co-precipitation in the form of (aqueous) dispersion or (aqueous) emulsion thereof

The water-insoluble solid organic compounds may be classified as drugs, agricultural chemicals, veterinary drugs, pigments, dyes (colorants), essences, antibiotics, anti mold agent, catalysts, polymer resins, or organic dyes. Specific names of these organic compounds within the scope of protection of the present invention may be found in relevant books like Pharmacopoeia of the People's Republic of China (2010 Edition), Encyclopedia of Agricultural Chemicals of China, A Handbook of Fine Chemical Industry, etc.

Micronization of insoluble organic compounds has great practical significance. For example, as for drugs, 40% or more of drugs are water-insoluble, and therefore it is obvious that micronization of these drugs has significant impacts on improvement of the dissolution rate and efficacy of these drugs. However, since the compatibility between inorganic and organic compounds is generally poor, it is often difficult to produce an ideal effect by dispersing and carrying organic compounds using inorganic particles as the carrier. Because the inorganic micronized particles according to the present invention are advantageous in that they can be flexibly surface-modified and be flexibly adjusted between hydrophilicity and lipophilicity, the compatibility can be improved to a maximum extent, so as to obtain ideally micronized insoluble organic compounds. Furthermore, the numerous possibilities for modification imparted by the micronized particles allows for facilitated drug encapsulation and provides the basis for controlled and delayed release of drugs.

The above embodiments are not the only options, and do not limit the present invention.

The preferred examples are provided below to describe the present invention in details, which are exemplary illustration of the present invention and are not meant to limit the present invention.

### EXAMPLE 1

At room temperature, i.e. 25° C., a 10 ml of 0.1 mol/l aqueous calcium chloride was added into a 50 ml beaker, in which a magnetic stirrer coated with polytetrafluoroethylene was placed, and a SH05-3 constant temperature magnetic mixer (Minhang Hongpu Instruments Factory, Shanghai) was set at its maximum rpm. Then 5 ml of 0.1 mol/l aqueous sodium carbonate and 0.2 mol/l sodium hydroxide was added dropwise within 1 minute from above the center of a vortex created by the magnetic stirrer. After the addition was finished, the system was further stirred for about 1 hour, and was allowed to settle down and age.

After 10 hours, the suspension containing a precipitate of calcium carbonate and calcium hydroxide was filtered. The resultant filtrate cake was put into a 50 ml beaker, to which an 8 ml of 0.1 mol/l aqueous hydrochloric acid was slowly added under vigorous stirring driven by the magnetic mixer. After 30 minutes, the system was further filtrated, and washed with about 10 ml water under stirring; and the filtration and washing were repeated for another 3 times. Water-soluble calcium chloride in the filtrate and washed-out water is treated by a recycling method using pure alkaline.

The slurry of calcium carbonate precipitate washed with water was put into a 50 ml plastic beaker, to which a 30 ml aqueous solution containing 2% dispersant DEMOL N (naphthalene sulfonate formaldehyde condensate, Kao Corporation, Japan) was further added. The solution was then forced to disperse for 20 minutes with a GF 1110 laboratory dispersion machine (Shenglong Machinery Factory, Shandong, China) running at 1200 rpm.

The slurry after dispersion was analyzed for the particle size with a laser particle size analyzer (Beckman coulter), and it can be seen that the volume average value of the secondary particle size d50 of the calcium carbonate precipitate is about 30 nm.

### EXAMPLE 2

The processes in Example 1 were repeated except that the obtained calcium carbonate was dispersed in 30 ml liquid paraffin containing 0.1% oleic acid, in a 30 ml aqueous solution containing 0.1% oleic acid and 0.1% penetrant JFC, in a 30 ml aqueous solution containing 0.1% anionic organic dye Fluorescence Yellow and 0.1% nonionic surfactant penetrant JFC, and in a pure acrylic emulsion named AT containing 3% acrylic acid groups (Antex Chemicals (Zhongshan) Ltd.).

The calcium carbonate in the above liquids was all well dispersed, and the deaggregation effect of the calcium carbonate is substantially the same as that in Example 1.

### EXAMPLE 3

The same processes as in Example 1 were repeated except that 10 ml aqueous suspension of 0.1 mol/l calcium oxide was added into a 50 ml sealed flask and gaseous carbon dioxide was bubbled into the suspension until the pH reached about 10.5. After aging, the pH of the system was adjusted to about 9 with hydrochloric acid. The system was then repeatedly washed and further dispersed.

The slurry after dispersion was analyzed for the particle size with a laser particle size analyzer (Beckman coulter), and it can be seen that the volume average value of the secondary particle size d50 of the calcium carbonate precipitate is about 80 nm.

### EXAMPLE 4

The same processes as in Example 1 were repeated except that 10 ml of 0.1 mol/l aqueous silicon oxide and 0.1 mol/l sodium carbonate (a mixture of water glass and sodium carbonate) was added into a 50 ml sealed flask, to which 10 ml of 0.2 mol/l calcium chloride was further added; the flask was heated at 80° C. for 2 hours and settled for 24 hours; 10 ml of 0.2 mol/l hydrochloric acid was further added; and the system was then repeatedly washed and further dispersed.

The slurry after dispersion was analyzed for the particle size with a laser particle size analyzer (Beckman coulter), and it can be seen that the volume average value of the secondary particle size d50 of the calcium silicate precipitate (a complex of calcium oxide hydrate and silicon oxide) is about 50 nm.

### EXAMPLE 5

The same processes as in Example 1 were repeated except that 10 ml of 0.1 mol/l aqueous silicon oxide and 0.1 mol/l sodium carbonate (a mixture of water glass and sodium carbonate) was added into a 50 ml sealed flask, to which 10 ml of 0.2 mol/l calcium chloride was further added; the flask was heated at 80° C. for 2 hours and settled for 24 hours; 0.5 g of finely ground ultrafine carbon powder (200 mesh or more) was further added; the system was intensively washed, concentrated, and dried after being sufficiently dispersed; the product was put in a tray made of 99% or more corundum, and was heated slowly to 1500° C. at which the reaction proceeded for 10 hours under the protection of argon gas passed (at 50 ml/min) in a DC-R tube high-temperature furnace (tube furnace); then the mixed precipitate was maintained at 750° C. in air for 3 hours to remove carbon; and finally hydrochloric acid was used to remove calcium-based compounds and hydrofluoric acid was used to remove unreacted silicon dioxide and other substances, so as to obtain micronized particles of silicon carbide.

The slurry after dispersion was analyzed for the particle size with a laser particle size analyzer (Beckman coulter), and it can be seen that the volume average value of the secondary particle size d50 of the silicon carbide precipitate is about 900 nm.

### EXAMPLE 6

The same processes as in Example 1 were repeated except that 10 ml of 0.1 mol/l aqueous ferric chloride and 0.02 mal calcium chloride was added into a 50 ml sealed flask, to which 5 ml of 0.7 mol/l sodium hydroxide was further added to allow for co-precipitation; and the product was washed and dispersed without acidolysis.

The slurry after dispersion was analyzed for the particle size with a laser particle size analyzer (Beckman coulter), and it can be seen that the volume average value of the secondary particle size d50 of the colloidal precipitate of ferric hydroxide is about 30 nm.

The above washed mixed precipitate of ferric hydroxide and calcium hydroxide was sufficiently dispersed in 10 ml 1,2-propylene glycol, heated to dryness, and put into a muffle furnace where it was calcined at 500° C. to afford micronized ferric oxide. The ferric oxide was reduced with carbon monoxide in a DC-R tube high-temperature furnace (tube furnace) at 450° C. to afford magnetic ferroferric oxide.

This iron oxide was sand-ground for 1 hour in an aqueous solution containing 2% dispersant DEMOL N (naphthalene sulfonate formaldehyde condensate, Kao Corporation, Japan) in a GF1110 laboratory dispersion machine, and the volume average value of the secondary particle size d50 of the resultant is about 580 nm.

### EXAMPLE 7

The same processes as in Example 1 were repeated except that 10 ml of 0.1 mol/l aqueous aluminum chloride and 0.02 mol/l calcium chloride was added into a 50 ml sealed flask, to which 5 ml of 0.7 mol/l sodium hydroxide was further added to allow for co-precipitation; after the mixed precipitate aged, it was subjected to acidolysis with 10 ml of 0.06 mol/l hydrochloric acid and then washed and concentrated; the obtained aluminum hydroxide precipitate was sufficiently dispersed in 10 ml of 1,2-propylene glycol, and then dried in an oven at 300° C.; and the dried product was further put into a muffle furnace where it was calcined at 1000° C. for 3 hours.

The resultant aluminum oxide (α-alumina, also referred to as corundum) was dispersed and analyzed for the particle size with a laser particle size analyzer (Beckman coulter), and it can be seen that the volume average value of the secondary particle size d50 of the aluminum oxide is about 350 nm.

### EXAMPLE 8

The same processes as in Example 1 were repeated except that 10 ml mixed solution of 0.2 mol/l aqueous aluminum nitrate and 0.05 mol/l silver nitrate was added into a 50 ml beaker, which was then heated to 60° C.; 5 ml solution of 1.4 mol/l sodium hydroxide was further added dropwise to allow for reaction, and then 0.01 g solution of hydrazine hydrate (80% in content) was added; after the mixed precipitate aged for 24 hours, concentrated, and washed, it was subjected to acidolysis with 9.5 ml of 0.7 mol/l nitric acid, and then washed and concentrated.

The resultant elemental silver was dispersed and analyzed for the particle size with a laser particle size analyzer (Beckman coulter), and it can be seen that the volume average value of the secondary particle size d50 of the silver is about 160 nm.

### EXAMPLE 9

The same processes as in Example 1 were repeated except that 10 ml mixed solution of 0.2 mol/l aqueous magnesium chloride and 0.05 mol/l cupric sulfate was added into a 50 ml beaker, which was then heated to 80° C.; 5 ml of 2 mol/l sodium hydroxide was further added dropwise to allow for reaction, and then 0.01 g of hydrazine hydrate solution (80% in content) was added; after the mixed precipitate aged for 24 hours, concentrated, and washed, it was subjected to acidolysis with 9.5 ml of 1 mol/l hydrochloric acid, and then washed and concentrated.

The resultant elemental copper was dispersed and analyzed for the particle size with a laser particle size analyzer (Beckman coulter), and it can be seen that the volume average value of the secondary particle size d50 of the copper is about 350 nm.

### EXAMPLE 10

The same processes as in Example 1 were repeated except that 10 ml mixed solution of 0.2 mol/l aqueous magnesium sulfate and 0.05 mol/l cupric sulfate was added into a 50 ml beaker, which was then heated to 80° C.; 10 ml of 1 mol/l sodium hydroxide was further added dropwise to allow for reaction; after the mixed precipitate aged for 24 hours, concentrated, and washed, it was subjected to acidolysis with 9.5 ml of 1 mol/l hydrochloric acid, and then washed and concentrated.

The resultant cupric oxide was dispersed and analyzed for the particle size with a laser particle size analyzer (Beckman coulter), and it can be seen that the volume average value of the secondary particle size d50 of the cupric oxide is about 50 nm.

### EXAMPLE 11

The same processes as in Example 1 were repeated except that 10 ml of 0.1 mol/l aqueous silver nitric and 0.1 mol/l aluminum nitric was added into a 50 ml beaker, to which 10 ml of 0.3 mol/l aqueous sodium hydroxide and 0.1 mol/l sodium chloride (also containing 0.015 g oleic acid) was further added dropwise to allow for reaction; after being washed, concentrated, and aged, the mixed precipitate was subjected to acidolysis with 9.5 ml of 0.3 mol/l nitric acid, and then further washed and concentrated.

The resultant silver chloride was dispersed and analyzed for the particle size with a laser particle size analyzer (Beckman coulter), and it can be seen that the volume average value of the secondary particle size d50 of the silver chloride is about 320 nm.

### EXAMPLE 12

The same processes as in Example 1 were repeated except that 5 ml of 0.2 mol/l aqueous calcium chloride was added into a 25 ml beaker, to which 5 ml of 0.12 mol/l sodium phosphate and 0.04 mol/l sodium hydroxide was further added dropwise; when the system was heated to 80° C., 0.01 g stearic acid was further added under vigorous stirring to allow for reaction, after the temperature was maintained for 10 minutes, the system was cooled down to room temperature under vigorous stirring; after the mixed precipitate was concentrated and washed, it was subjected to acidolysis with 5 ml of 0.1 mol/l aqueous hydrochloric acid, and then dispersed.

The resultant mixed precipitate of calcium phosphate and calcium stearate was dispersed and analyzed for the particle size with a laser particle size analyzer (Beckman coulter), and it can be seen that the volume average value of the secondary particle size d50 of the mixed precipitate is about 350 nm.

0.01 g fish liver oil was added dropwise into the above dispersion, and the dispersion was vigorously stirred to give an aqueous emulsion of fish liver oil, of which the volume average value of the secondary particle size d50 is also about 350 nm.

### EXAMPLE 13

The same processes as in Example 1 were repeated except that 10 ml of 0.2 mol/l aqueous calcium chloride was added into a 50 ml beaker, to which a 10 ml mixed solution of 0.07 mol/l sodium phosphate and 0.1 mol/l sodium carbonate was further added dropwise to allow for reaction; and 0.1 g 10% IPBC (iodopropynyl carbamate, an excellent industrial anti mold agent) solution in methanol was further added; the mixed precipitate aged, subjected to acidolysis with 10 ml of 0.2 mol/l hydrochloric acid, and then washed and concentrated before dispersion.

The resultant mixed precipitate of calcium phosphate and IPBC was dispersed and analyzed for the particle size with a laser particle size analyzer (Beckman coulter), and it can be seen that the volume average value of the secondary particle size d50 of the mixed precipitate is about 300 nm.

### EXAMPLE 14

The same processes as in Example 13 were repeated except that the IPBC was replaced with 0.1 g 10% climbazole solution in 1,2-propylene glycol, with 0.1 g 10% ketoconazole solution in methanol. As a result, a good aqueous dispersion of these two medicine agents can be obtained as well, and both the volume average values of their secondary particle size d50 are about 300 nm.

### EXAMPLE 15

The same processes as in Examples 14 were repeated except that the aqueous solution containing the dispersant DEMOL N was replaced with an aqueous solution containing 1% ICM-7 sodium carboxymethyl cellulose (ZHANGJIAGANG SANHUI Chemicals Industry Co. Ltd., the degree of hydroxyl substitution thereof is about 0.7), and as a result a good aqueous dispersion of the mixed precipitate can still be obtained.

### EXAMPLE 16

The same processes as in Example 1 were repeated except that 5 ml of 0.2 mol/l aqueous calcium chloride was added into a 50 ml beaker, to which 5 ml of 0.14 mol/l aqueous sodium phosphate was further added dropwise to allow for reaction; under vigorous stirring, 1 ml of 0.04 mol/l aqueous sodium iodide and 1 ml of 0.006 g propynyl butyl carbamate (a water-insoluble liquid) solution in methanol were added; after the temperature was decreased to 10° C., 5 ml of 0.005 mol/l aqueous sodium hypochlorite was slowly added dropwise, so as to synthesize a mixed precipitate of IPBC and calcium phosphate, which was directly dispersed without acidolysis, after being washed and concentrated.

The resultant mixed precipitate of calcium phosphate and IPBC was dispersed and analyzed for the particle size with a laser particle size analyzer (Beckman coulter), and it can be seen that the volume average value of the secondary particle size d50 of the mixed precipitate is about 360 nm.

### EXAMPLE 17

At room temperature, i.e. 25° C., the following solutions were prepared.

A. 20 kg of 0.2 mol/l aqueous 2-mercaptopyridine oxide sodium;

B. 20 kg of 0.22 mol/l aqueous zinc sulfate;

C. 20 kg of 0.1 mol/l aqueous sodium carbonate (containing 0.2 mol sodium oleate).

Above aqueous solutions A and B were simultaneously pumped, under a condition that the flow of each solution was not more than 200 L/H and the molar ratio between their flows was about 1:1.1, into a supergravity reactor for synthesis. The supergravity reactor rotates at 1000 rpm. The synthesized slurry from A and B was put into a 100 L polypropylene plastic bucket, and was treated in a GFJ-8 dispersion machine which was set at 1000 rpm, while C was added in the synthesized slurry of A and B within 10 minutes.

The resultant slurry was treated according to Example 1, wherein a general sedimentation-type tripod centrifuge was selected as the centrifuging device, and the dispersant DEMOL N (naphthalene sulfonate formaldehyde condensate, Kao Corporation, Japan) was selected as the dispersant. The modified micronized 2-mercaptopyridine oxide zinc obtained in this example was analyzed for the particle size with scanning electron microscope (SEM), and it can be seen that the particle size of its particles is substantially below 300 nm.

### COMPARATIVE EXAMPLE 1

5 ml of 0.1 mol/l aqueous calcium chloride and 5 ml of 0.1 mol/l aqueous sodium carbonate were prepared and treated according to Example 1. The calcium carbonate produced by a method other than the method of the present invention was analyzed with a laser particle size analyzer (Beckman coulter) and its d50 is about 8.5 μm. Therefore it can be seen that the inorganic precipitate calcium hydroxide can effectively improve the quality of calcium carbonate in terms of secondary particle size.

### COMPARATIVE EXAMPLE 2

At room temperature, i.e. 20° C., 20 kg of 6.8% (w/w, the same applies hereinafter) aqueous zinc sulfate was prepared (the pH of the solution was adjusted to 4-4.5 with sulfuric acid), which further contained 1% dispersant DEMOL N (naphthalene sulfonate formaldehyde condensate, Kao Corporation, Japan); another 15 kg of 20% aqueous 2-mercaptopyridine oxide sodium was prepared, which also contained 1% dispersant DEMOL N (naphthalene sulfonate formaldehyde condensate, Kao Corporation, Japan).

The above aqueous solutions of zinc sulfate and of 2-mercaptopyridine oxide sodium were simultaneously pumped, under a condition that the flow of each solution was not more than 200 L/H and the molar ratio between their flows was about 1.05:1, into a supergravity reactor for synthesis. The supergravity reactor rotates at 1000 rpm.

The resultant slurry was filtered with quantitative filter paper, and as a result a large amount of modified micronized 2-mercaptopyridine oxide zinc particles passed through the filter paper, indicating that this method cannot effect separation of modified micronized 2-mercaptopyridine oxide zinc particles from the reaction mother liquid.

The resultant slurry was centrifuged for 20 minutes in a Low Speed Desktop Centrifuge 80-2T (Shanghai Surgical Instruments Factory) running at 3000 rpm for separation, and a large amount of modified micronized 2-mercaptopyridine oxide zinc particles and the dispersant DEMOL N still remained in the mother liquid separated out by centrifuging, indicating that good separation between the reaction product and the reaction mother liquid still cannot be achieved.

The above examples were described in order to allow a person ordinarily skilled in the art to easily understand and carry out the present invention. Obviously, a person skilled in the art will readily make various modifications to these examples and apply the general principles set forth herein to other examples without putting in any creative work. Therefore, the present invention is not limited to the examples provided herein, and any improvement and modification made by a person skilled in the art inspired by the present invention without departing from the spirit thereof should be included in the scope of protection of the present invention.

1. A method for preparing modified micronized particles, characterized in that the method comprises the steps of
carrying out co-precipitation in an aqueous solution at a temperature between the freezing point and the boiling point of the reaction mother liquid to produce a mixed precipitate of micronized particles or precursors thereof and an inorganic precipitate.

2. The method for preparing modified micronized particles according to claim 1, characterized in that the mixed precipitate of micronized particles or precursors thereof and an inorganic precipitate accounts for 0.1%-50%, preferably 0.5%-10%, of the mother liquid after reaction; and the mass ratio of the precipitated micronized particles or precursors thereof to the inorganic precipitate is from 1000:1 to 1:100000, preferably from 100:1 to 1:1000, and most preferably from 10:1 to 1:100.

3. The method for preparing modified micronized particles according to claim 1, characterized in that the co-precipitation is carried out under a condition of typical stirring, or a condition of high-speed stirring/mixing/shearing/friction, and further carried our under a condition of supergravity.

4. The method for preparing modified micronized particles according to claim 1, characterized in that for the co-precipitation the pH of the reaction liquid is controlled within the range of 3-14, preferably 7-14.

5. The method for preparing modified micronized particles according to claim 1, characterized in that the micronized particles or precursors thereof are inorganic or organic substances insoluble in water and chemically non-reactive with water, or a mixture thereof.

6. The method for preparing modified micronized particles according to claim 5, characterized in that
the inorganic substance is selected from chemical elements, and in particular is selected from Zn, Cr, Ga, Fe, Cd, In, TI, Co, Ni, Mo, Sn, Pb, Cu, Tc, Po, Ag, Rh, Pd, Pt, Au, C, Si, W, B, Te, Se, S, or I, or a mixture thereof;
the inorganic substance is selected from hydroxides, and in particular is selected from actinium hydroxide, palladium(II, IV) hydroxide, bismuth hydroxide, platinum hydroxide, erbium hydroxide, gadolinium hydroxide, cadmium hydroxide, hafnium(III, IV) hydroxide, holmium hydroxide, gallium hydroxide, lutetium hydroxide, aluminum hydroxide, magnesium hydroxide, manganese hydroxide, lead(II, IV) hydroxide, cerium(III, IV) hydroxide, ferric hydroxide, ferrous hydroxide, cuprous hydroxide, cupric hydroxide, indium hydroxide, europium hydroxide, beryllium hydroxide, zinc hydroxide, nickel hydroxide, tin hydroxide, lanthanum hydroxide, neodymium hydroxide, praseodymium hydroxide, samarium hydroxide, terbium hydroxide, yttrium hydroxide, dysprosium hydroxide, thulium hydroxide, ytterbium hydroxide, scandium hydroxide, plutonium hydroxide, thorium hydroxide, neptunium hydroxide, uranium hydroxide, titanium hydroxide, zirconium hydroxide, vanadium(II, Ill, IV) hydroxide, niobium hydroxide, tantalum hydroxide, chromium hydroxide, cobalt hydroxide, or molybdenum(III, IV, V) hydroxide;
the inorganic substance is selected from oxides, and in particular is selected from actinium oxide, palladium(II, IV) oxide, bismuth oxide, platinum oxide, erbium oxide, gadolinium oxide, cadmium oxide, hafnium(III, IV) oxide, holmium oxide, gallium oxide, lutetium oxide, aluminum oxide, magnesium oxide, manganese oxide, lead(II, IV) oxide, cerium(III, IV) oxide, ferric oxide, ferrous oxide, cuprous oxide, cupric oxide, indium oxide, europium oxide, beryllium oxide, zinc oxide, nickel oxide, tin oxide, lanthanum oxide, neodymium oxide, praseodymium oxide, samarium oxide, terbium oxide, yttrium oxide, dysprosium oxide, thulium oxide, ytterbium oxide, scandium oxide, plutonium oxide, thorium oxide, neptunium oxide, uranium oxide, titanium oxide, zirconium oxide, vanadium(II, Ill, IV) oxide, niobium oxide, tantalum oxide, chromium oxide, cobalt oxide, molybdenum(III, IV, V) oxide, silver oxide, technetium oxide, polonium oxide, rhodium oxide, palladium oxide, platinum oxide, gold oxide, silicon oxide, tungsten oxide, boron oxide, tellurium oxide, or selenium oxide;
the inorganic substance is selected from inorganic salts, and in particular is selected from barium arsenate, barium carbonate, barium chromate, barium ferrocyanide, barium fluorosilicate, barium fluoride, barium hydrogen phosphate, barium iodate, barium sulfate, barium molybdate, barium permanganate, barium pyrophosphate, barium selenate, bismuth arsenate, bismuth iodide, bismuth phosphate, bismuth sulfide, platinum(IV) bromide, plutonium(III) fluoride, plutonium(IV) fluoride, plutonium(IV) iodate, calcium arsenate, calcium fluoride, calcium hydrogen phosphate, calcium molybdate, calcium phosphate, calcium tungstate, cadmium arsenate, cadmium carbonate, cadmium cyanide, cadmium ferrocyanide, cadmium iodate, cadmium phosphate, cadmium sulfide, cadmium tungstate, mercurous azide, mercurous bromide, mercurous carbonate, mercurous chloride, mercurous chromate, mercurous cyanide, mercurous sulfate, mercuric iodate, mercuric iodide, mercuric sulfide, mercuric thiocyanide, potassium tetraphenylborate, gold triiodide, lanthanum iodate, lanthanum molybdate, lithium phosphate, magnesium fluoride, magnesium phosphate, magnesium selenite, manganese carbonate, manganese ferrocyanide, nickel carbonate, nickel iodate, nickel pyrophosphate, polonium(II) sulfide, praseodymium(III) molybdate, lead azide, lead carbonate, lead chlorate, lead chromate, lead ferrocyanide, lead fluoride, lead hydrogen phosphate, lead hydrogen phosphite, lead iodate, lead iodide, lead molybdate, lead selenate, lead sulfate, lead sulfide, lead thiosulfate, lead tungstate, lead telluride, cerium(III) phosphate, strontium chromate, strontium sulfate, thallous bromide, thallous iodate, thallous iodide, ferrous carbonate, ferrous hydroxide, ferric arsenate, ferric fluoride, cuprous chloride, cuprous cyanide, cuprous iodide, cuprous sulfide, cuprous thiocyanide, cupric carbonate, cupric chromate, cupric fluoride, cupric selenite, cupric sulfide, thorium(IV) iodate, zinc carbonate, zinc cyanide, zinc iodate, yttrium fluoride, indium iodate, indium sulfide, silver azide, silver bromide, silver carbonate, silver chloride, silver chromate, silver cyanide, silver vanadate, beryllium carbonate, barium sulfite, strontium sulfite, calcium sulfite, beryllium sulfite, manganese sulfite, zinc sulfite, cadmium sulfite, ferrous sulfite, nickel sulfite, lead sulfite, cupric sulfite, mercuric sulfite, silver sulfite, strontium sulfide, manganese sulfide, zinc sulfide, ferrous sulfide, cadmium sulfide, nickel sulfide, tin sulfide, lead sulfide, cupric sulfide, mercuric sulfide, silver sulfide, barium silicate, calcium silicate, magnesium silicate, aluminum silicate, beryllium silicate, manganese silicate, zinc silicate, chromium silicate, ferrous silicate, ferric silicate, cadmium silicate, nickel silicate, lead silicate, cupric silicate, silver silicate, lithium phosphate, barium phosphate, strontium phosphate, calcium phosphate, magnesium phosphate, aluminum phosphate, beryllium phosphate, manganese phosphate, zinc phosphate, chromium phosphate, ferrous phosphate, ferric phosphate, cadmium phosphate, thallium phosphate, nickel phosphate, tin phosphate, lead phosphate, cupric phosphate, mercuric phosphate, silver phosphate, 2-mercapto zinc pyrithione, 2-mercapto copper pyrithione, cadmium oxalate, silver oxalate, ferrous oxalate, zinc tartrate, zinc oxalate, lead oxalate, lead tartrate, barium oxalate, calcium oxalate, mercuric oxalate, scandium oxalate, manganese oxalate, tungsten carbide, silicon carbide, boron carbide, silicon nitride, or boron nitride; or
the inorganic substance is selected from organic metal salts, and in particular is selected from any salt formed by an anion of alkyl or aryl sulfate, sulfonate, phosphate, or carboxylate and the ion of Ba, Sr, Ca, Li, Ac, La, Ce, Pr, Nd, Sm, Eu, Gd, Tb, Y, Mg, Am, Dy, Ho, Er, Tm, Yb, Lu, Sc, Pu, Th, Np, Be, U, Hf, Al, Ti, Zr, V, Mn, Nb, Zn, Cr, Ga, Fe, Cd, In, TI, Co, Ni, Mo, Sn, Pb, Cu, Tc, Po, Hg, Ag, Rh, Pd, Pt, or Au; and
the organic substance has at least one of the following characteristics:
(1) its decomposition temperature is higher than its melting point, and
(2) at or below its decomposition temperature, it is soluble in any liquid or liquid composition other than water, with a solubility not less than 1 g/100 g.

7. The method for preparing modified micronized particles according to claim 1, characterized in that the method further comprises a step of adding a purifying agent into the mixed precipitate, removing part or all of the inorganic precipitate and post-transformed products thereof by converting them into soluble substances, and washing and concentrating the remaining precipitate.

8. The method for preparing modified micronized particles according to claim 7, characterized in that the purifying agent is a water-soluble inorganic or organic acid, and is one selected from hydrochloric acid, sulfuric acid, nitric acid, hydrofluoric acid, acetic acid and phosphoric acid, or a mixture thereof.

9. The method for preparing modified micronized particles according to claim 7, characterized in that the method further comprises a step of allowing the purified mixed precipitate to mix/react with a surface modifying agent to obtain modified micronized particles.

10. The method for preparing modified micronized particles according to claim 9, characterized in that the surface modifying agent refers to a compound able to be adsorbed to the surface of the micronized particles, and includes anionic compounds, cationic compounds, nonionic surfactants, water-insoluble organic liquids, coupling agents, or matrix materials, to which the particles are added, and compositions thereof.

11. The method for preparing modified micronized particles according to claim 9, characterized in that the volume average value of the secondary particle size d50 of the modified micronized particles is less than 10 pm, preferably less than 1000 nm, more preferably less than 100 nm, and most preferably less than 10 nm.

12. The method for preparing modified micronized particles according to claim 1, characterized in that the micronized particles or precursors thereof are precipitated in an aqueous solution at a temperature between the freezing point and the melting point of the mother liquid in the presence of an inorganic precipitate that can be converted into soluble substances.

13. The method for preparing modified micronized particles according to claim 12, characterized in that
the inorganic precipitate that can be converted into soluble substances has solubility at the reaction temperature of less than 1 g/100 g water, preferably less than 0.01 g/100 g water;
the cation portion of the inorganic precipitate is selected from ions of Ba, Sr, Ca, Li, Ac, La, Ce, Pr, Nd, Sm, Eu, Gd, Tb, Y, Mg, Am, Dy, Ho, Er, Tm, Yb, Lu, Sc, Pu, Th, Np, Be, U, Hf, Al, Ti, Zr, V, Mn, Nb, Zn, Cr, Ga, Fe, Cd, In, TI, Co, Ni, Mo, Sn, Pb, Cu, Tc, Po, Hg, Ag, Rh, Pd, Pt, and Au, or a mixture thereof; and
the anion portion of the inorganic precipitate is selected from a cyanide ion, a halide ion, a (hydrogen) sulfate ion, a nitrite ion, a (hydrogen) carbonate ion, a (hydrogen) sulfite ion, a bichromate ion, a (hydrogen) phosphate ion, a (hydrogen) sulfide ion, a chromate ion, a silicate ion, a borate ion, an arsenate ion, a titanate ion, an oxalate ion, a hydroxide ion, or a oxide ion, and in particular may be a hydroxide ion, an oxide ion, a (hydrogen) sulfide ion, a (hydrogen) sulfite ion, a (hydrogen) phosphate ion, and a (hydrogen) carbonate ion, or a mixture thereof.

14. The method for preparing modified micronized particles according to claim 1, characterized in that the method further comprises adding a surfactant substance before, during, and/or after the precipitation, and such addition does not influence separation of the mixed precipitate from the mother liquid or the treatment of the waste water.
